(19) United States
(12) Patent Application Publication
(10) Pub. No.: US 2009/0301522 A1
(43) Pub. Date: Dec. 10, 2009

(54) Customized Programmable Pool Cleaner Method and Apparatus

(75) Inventors: Ben Abehasera, Boynton Beach, FL (US); Omry Porat, Delray Beach, FL (US)

Correspondence Address: ABELMAN, FRAYNE & SCHWAB, 666 THIRD AVENUE, 10TH FLOOR, NEW YORK, NY, 10017, US

(73) Assignee: AQUATRON INC., Delray Beach, FL (US)

(21) Appl. No.: 11/992,821

(22) PCT Filed: Oct. 17, 2006
(86) PCT No.: PCT/US2006/040858

§ 371 Date: Mar. 26, 2008

Related U.S. Application Data
(60) Provisional application No. 60/728,248, filed on Oct. 18, 2005.

(51) Int. Cl. B08B 7/04

(52) U.S. Cl. 134/18

(57) ABSTRACT

A method and apparatus for cleaning the surfaces of a pool by a programmed robotic pool cleaner initially set at an arbitrary position in the poll. The pool can be of any standard or non-standard shapes, and the surfaced with any conventional materials. The robot is advanced until it encounters a first obstacle (1), then reverses direction and advances along the same path to an opposing second obstacle (2) to form a first path between the opposing first (1) and second (2) obstacles. At the second obstacle (2), the robot reverses and advances to a predetermined point (A) between the opposing obstacles along said first path. At the predetermined point (A), the robot stops and turns in a first direction at a predetermined angle of turn, and repeats the above steps along additional paths until the sum of the predetermined angle of turns generates a quantity of paths sufficient to substantially clean the pool surfaces.

### CROSS REFERENCE TO RELATED APPLICATION

This patent application claims the benefit of U.S. Provisional Application Ser. No. 60/728,248, filed Oct. 18, 2005, the contents of which are incorporated by reference herein.

### FIELD OF THE INVENTION

The present invention relates to robotic pool cleaners and more specifically to apparatus and methods for the programmed operation of pool cleaners for the efficient cleaning of a pool.

### BACKGROUND OF THE INVENTION

Automatic or robotic pool cleaners available having various navigational capabilities and methods for cleaning the bottom and side walls of a pool are disclosed in the art. For example, U.S. Pat. No. 6,125,492 (Prowse), entitled Automatic Swimming Pool Cleaning Device, discloses an automatic swimming pool cleaner which includes a flexible cleaning member designed to contact an underwater surface of the swimming pool. A tube is coupled to the cleaning member for connecting the cleaning device to a water vacuum hose via a hose adapter. Water and pool surface contamination is drawn from underneath the cleaning member up through the tube by suction to a water filter system before being returned to the pool. A flexible valve member is mounted proximate a throat region of the tube wherein as water is drawn up through the tube a decrease in pressure in the throat region causes the valve member to flex and momentarily interrupt the flow of water. The interruption to the flow of water through the tube results in a momentary differential of ambient pressure underneath the flexible cleaning member which enables the submerged device to incrementally move forwards along the surface of the pool.

U.S. Pat. No. 6,099,658 (Porat), entitled Apparatus and Method of Operation for High-Speed Swimming Pool Cleaner, discloses an apparatus and method for cleaning the bottom surface and vertical side walls of a swimming pool, pond or tank employing a robotic, self-propelled cleaner. The robot has a protective housing of conventional design, the cleaner being operated at a primary cleaning speed as it traverses the surfaces to be cleaned and until the cleaner housing emerges from the water along a sidewall of the pool; thereafter the cleaner reverses direction and descends for a predetermined period of time at a slower secondary speed in order to permit air entrained under the housing to escape without destabilizing the cleaner during its descent. After the predetermined period of time, the cleaner resumes operation at the more rapid primary speed until the cleaner housing once again emerges from the water's surface, after which the cycle is repeated.

In U.S. Pat. No. 5,086,535 (Grossmeyer et al.), entitled Machine and Method Using Graphic Data for Treating a Surface, a machine is disclosed for cleaning a surface area within a boundary perimeter that includes a self-propelled chassis having a surface treating device mounted on it. A computing section is mounted on the chassis and one or more powered wheels includes a motor module for receiving command signals from the computing section. A position sensor is coupled to the computing section for generating a feedback signal representing the actual position of the machine. A data loading device co-acts with the computing section for transmitting data to the computing section. A data file stores graphic data developed from a graphic depiction representing the surface area to be treated, as well as other data developed in other ways. The data file co-acts with the computing section and transmits the graphic and other data to it. The computing section is arranged for processing the data and the feedback signal and responsively generating command signals directed to each motor module which propel the machine over a selected surface area that is treated.

U.S. Pat. No. 5,569,371 (Perling), entitled System For Underwater Navigation and Control of Mobile Swimming Pool Filter, discloses an underwater navigation and control system for a swimming pool cleaning robot, that has driver, an impeller, a filter and a processor for controlling the driver and a signal-producing circuit. The system also has a signal-detecting circuit mounted on the pool, an interface located on the ground in proximity to the pool and a detector for receiving and processing data from the detecting circuit and for transmitting signals to the robot's processor. Determination of the robot's actual location is performed by triangulation in which the stationary triangulation base is defined by at least two spaced-apart signal detectors and the mobile triangle apex is constituted by the signal-producing circuit carried by the robot.

U.S. Pat. No. 5,197,158 (Moini), entitled Swimming Pool Cleaner, discloses a vacuum powered automatic swimming pool cleaning device having a housing supported on two pairs of device mover wheels. The housing includes a central water suction chamber in water flow communication with a water suction trough at the bottom of the housing and in water outlet communication with an external vacuum line, a gear train for driving one of the pairs of mover wheels, and pivoted directional control floats. The water suction chamber houses an axle-mounted water turbine having an output drive gear which intermeshes with one or the other of two shift gears which in turn reversibly drive the gear train as dictated by the position of the directional control floats within the housing. The floats swing shift within the housing to shift the shift gears in response to the impact of the cleaning device with an obstruction on the bottom of the pool or when the device contacts a vertical wall. The swing shift of the control floats reverses the rotation of the mover wheels and thus the direction of movement of the cleaning device on the bottom of the pool.

U.S. Pat. No. 4,786,334 (Nystrom), entitled Method of Cleaning the Bottom of a Pool, discloses a method of cleaning the bottom of a pool with the aid of a pool cleaner. The pool cleaner travels along the bottom of the pool and collects material lying at the bottom of the pool. The pool cleaner is arranged to travel to and fro in straight, parallel paths between two opposite walls of the pool. At the walls the pool cleaner is turned by rotating a half turn so that, after turning, it will have been displaced laterally parallel to the initial direction of travel.

In U.S. Pat. No. 4,593,239 (Yamamoto), entitled Method and Apparatus for Controlling Travel of an Automatic Guided Vehicle, an automatic guided is disclosed that vehicle detects marks located on a plurality of points along a route it travels using at least three sensors, selects the number of marks detected from each individual sensor as a reference value in accordance with the logic of majority, and stops when the reference value agrees with a predetermined value. Cumulative errors caused by misdetection are thus avoided and there is little cumulative error.

U.S. Pat. No. 4,700,427 (Kneppers), entitled Method of Automatically Steering Self-Propelled Floor-Cleaning Machines and Floor-Cleaning Machine for Practicing the Method, discloses a method of automatically steering a self-propelled floor-cleaning machine along a predetermined path of motion on a limited area to be worked. A sequence of path segments stored in a data memory is retrieved, and the path segments traveled by the machine. Markings are recognized by at least one sensor and converted into course-correcting control commands actuating and/or steering the machine.

U.S. Pat. No. 3,979,788 (Strausak) entitled Mobile Machine for Cleaning Swimming Pools, disclosed a Mobile Machine for Cleaning Swimming Pools by suction removal of sediment from the bottom of the swimming pools comprises a water turbine driving a drive wheel in such a way that the machine follows a self-steered path on the bottom of the swimming pools. The drive wheel is capable of rotating about a vertical steering axle to prevent the machine from becoming blocked at a wall or in a corner of the swimming pools.

U.S. Publication 2004/0021439 (Porat), entitled Pool Cleaning Method and Apparatus, discloses a method for cleaning the bottom of a pool by implementing an automated programmed pool cleaner capable of reversing movement and turning. The cleaner is initially placed at an arbitrary location on the bottom of the pool and moved in a forward direction until it encounters an upright pool wall; the unit is reversed until it is a first predetermined distance from the wall, turned through a predetermined angle less than 180 degrees and advanced until it again encounters an upright wall; these steps are repeated until the unit has encountered upright walls a predetermined number of times, after which the first predetermined distance is changed to one or more subsequent predetermined distances. All of the previous steps are repeated until all or substantially all of the pool has been cleaned.

It is noted that covering the bottom, and optionally, the side wall surfaces of a swimming pool efficiently and quickly is not simple a task, and various scanning algorithms have been disclosed to address this complex problem. Contributing to the complexity of the navigational problem is the fact that even though a robot is generally programmed to travel in straight lines from side to side and make accurate turns, it is difficult to keep it on the desired path and to complete the turns accurately. In fact a travel pattern of a pool cleaning robot is more likely to be deviated as the robot is subjected to different conditions and forces such as its own weight, the pull and weight of its floating power cord, underwater currents, different friction forces due to uneven surface elevation or texture, debris on the bottom of the pool, asymmetrically or even amorphically shaped pools. Consequently, all navigational algorithms for pool cleaning robots of the prior art depend on numerous and even repeated cycles of traversing the bottom of the pool in an effect to achieve substantial coverage for cleaning.

An analysis of some prior art algorithms for controlling the programmed movement of robotic cleaners indicates that they are inadequate and fail to substantially cover the pool's bottom surface.

It is therefore a purpose of the present invention to provide an improved method for directing the movement of a pool cleaning robot on the bottom and side walls of a pool. Another purpose of the present invention to provide a method and an apparatus for directing and controlling the movement of a pool cleaning robot that provides efficient and rapid cleaning of the bottom and side walls of a pool.

Still another object of the present invention is to provide such method and apparatus that allow high performance and coverage in cleaning irregularly shaped pools.

It is to be understood that the terms “robotic pool cleaner”, “pool cleaning robot” and “robot” are used interchangeably and are equivalent in meaning.

### SUMMARY OF THE INVENTION

The above objects and other advantages are obtained by the method and apparatus of the present invention for cleaning the surfaces of a pool by a pool cleaning robot that moves in accordance with the prescribed pre-programmed operational sequence (scanning algorithm) described in detail below. The programmed movement is effective in a pool of any of the conventional shapes and in irregularly shaped pools of custom design, and having a surface constructed from any of the materials conventionally used to surface pools.

The pool cleaner can initially be placed arbitrarily at any position in the pool, where it will sink to the bottom. In a preferred embodiment, a self-diagnostics test is performed. Upon successful completion of the self-diagnostics test, the pool cleaner advances in a first direction until it encounters a first obstacle, such as a wall, or the surface of the water while climbing a wall, or a structure in the pool.

Once the robot reaches the first obstacle, the robot reverses direction and, in one embodiment, moves along the same path on which it arrived to a second obstacle to trace a first path between the opposing first and second obstacles. At the second obstacle (e.g., the second wall), the robot again reverses direction and moves to a predetermined point along said first path between the opposing obstacles. Preferably, the predetermined point is located approximately at the midpoint along the path between the two opposing obstacles. Alternatively, the predetermined point is at a location in the range of from 30% to 70% along the path between the two opposing obstacles.

In one embodiment, the predetermined point is derived by an onboard microcontroller that measures and records the time it takes to traverse the path between the opposing obstacles. The time is measured by counting from the first obstacle and stopping upon reaching the second obstacle. The robot then reverses and travels for a time that corresponds to the predetermined location. For example, if the robot takes 50 seconds to traverse a path between opposing obstacles and the predetermined point is set as the midpoint (i.e., 50% of the time), then the robot travels back along the path for approximately 25 seconds.

At the predetermined point, the robot stops and turns in a first direction a predetermined angle, and repeats the above steps along additional paths. Preferably, the predetermined turn angle is based on the width of the robot to provide maximum coverage during cleaning. The programmed pattern of movement is repeated until a sum of the predetermined angular turns generates a number of paths sufficient to substantially clean the pool surfaces.

For example, a predetermined angle of turning (i.e., a turn angle) can be set for 15 degrees for a circular pool, which will generate approximately twenty-four paths to clean the entire pool. Preferably, the robot alternates between turning clockwise and counter-clockwise when a power cable extends from the robot to an external power source. Alternating the turning directions eliminates or minimizes twisting of the power cable which can interfere with the programmed movement of the pool cleaner.

There may be instances where the shape of the pool includes narrow passages or portions such that the robot's travel time between opposing walls is approximately four seconds or less. In this instance, the microcontroller of the robot resets the scanning algorithm, since the space between the walls is insufficient for robot to properly clean and return to the center of the pool in its current orientation.

In particular, upon reaching the second obstacle, the robot will climb along the nearest wall and clean to the waterline for a predetermined time (e.g., thirty seconds), and then turn in a new direction and proceed down the wall to another point along the bottom of the pool. The robot cleaner is capable of sensing its horizontal and vertical orientations, illustratively, by a mercury switch. Once the robot is positioned substantially horizontal along the bottom of the pool, the microprocessor resets to start the scanning algorithm process over again. In this manner, the robot is able to clean this narrow area, as well as the remaining portion of the pool from a different direction.

Thus, in one preferred embodiment, the apparatus of the invention is programmed to measure the time lapsed during transit between obstacles encountered in the pool, reverse direction, and then move along a path for about one-half of the measured time, where it effects a turn through a predetermined angle.

The program algorithm of the present invention can be factory installed or preferably installed by a dealer to customize the robot according to a user's pool specifications. In one embodiment, the dealer or end-user downloads the program, illustratively, from a memory storage device, such as a CD-ROM into the memory of an onboard microcontroller where the program is stored. Alternatively, the program for the scanning algorithm can be downloaded from a server over a private network, or public network, such as the Internet. The microcontroller includes a processing circuitry and associated support circuitry to execute the program from memory and control the navigation and operations of the robot.

In other alternative embodiments, the position of the pool cleaner between the obstacles is determined by means of a triangulation system, the GPS or ground positioning system, or a laser system. All of the methods and their applicability to pool cleaners are known in the art.

### BRIEF DESCRIPTION OF THE DRAWINGS

These and other features and advantages of the invention will be apparent from the following detailed description of the preferred embodiments taken in conjunction with the attached drawings, wherein like reference numerals denote like elements, where:

FIG. 1 illustrates a plurality of paths traveled by a pool cleaning robot in accordance with an embodiment of the present invention;

FIG. 2 is a flow diagram of a method for cleaning the pool by the pool cleaning robot in accordance with the present invention;

FIG. 3 is a flow diagram of a method for performing self diagnostics prior to initiating the pool cleaning method of FIG. 2;

FIG. 4 is a sectional view of a pool cleaning robot in accordance with the present invention;

FIG. 5 is a schematic block diagram of the functional components of a controller of the pool cleaner of FIG. 4;

FIG. 6 illustrates a path traveled by a pool cleaning robot in accordance with a second embodiment of the present invention;

FIG. 7 is a schematic block diagram of the electrical features of the pool cleaning robot of FIG. 4; and

FIG. 8 is a graphical representation of a graphical user interface for emulating performance and programming the pool cleaning robot from a remote computer device.

To facilitate understanding of the invention, the same reference numerals have been used, when appropriate, to designate the same or similar elements that are common to the figures. Further, unless stated otherwise, the drawings shown and discussed in the figures are not drawn to scale, but are shown for illustrative purposes only.

### DETAILED DESCRIPTION OF THE PREFERRED EMBODIMENTS

An important aspect of the present invention is a novel navigationed algorithm that is used in conjunction with a pool cleaner that introduces a systematic coverage of the submerged surfaces of the pool in a predetermined pattern. The present invention includes an algorithm that is programmed into, and executed by the controller of the cleaning robot to provide a novel cleaning routine. The algorithm provides a fast and efficient pattern of movement for cleaning a bottom surface, as well as the sidewalls of a swimming pool, spa, hot tub, recreational pond, or any other recreational aquatic structure that retains a volume of water and requires cleaning. By efficient, it is meant that the pool cleaner can traverse the bottom surface of the pool to clean all, or substantially all of the surface in a relatively short period of time.

One novel feature of the present invention is that the robot can efficiently clean a pool having either a conventional or an irregular shape. That is, the algorithm that is programmed into the processor is suitable for use in any round, oval, kidney-shaped, rectangular or polygonally shaped pool, as well as any custom-shaped pool, and does not require any changes to the program due to the shape of the pool. In other words, once the microcontroller has been programmed with the algorithm, the robot can be used efficiently, regardless of the shape of the pool that is to be cleaned.

The cleaning of the pool's bottom surface is carried out by directing pool cleaner to follow a series of paths across the bottom of the pool, typically from one side of the pool to the opposite side as it cleans the bottom surface. After reaching a first wall, the cleaner reverses direction and simultaneously begins counting the time until a second wall is reached. The lapsed travel time between two opposing walls is recorded. The robot then reverses and travels along a reverse path (also while cleaning) to a predetermined point (e.g., the mid-point) between the two opposing obstacles (e.g., walls). For example, if the travel time between the opposing walls was fifty seconds, then the mid-point is located after approximately twenty-five seconds of travel time along the path.

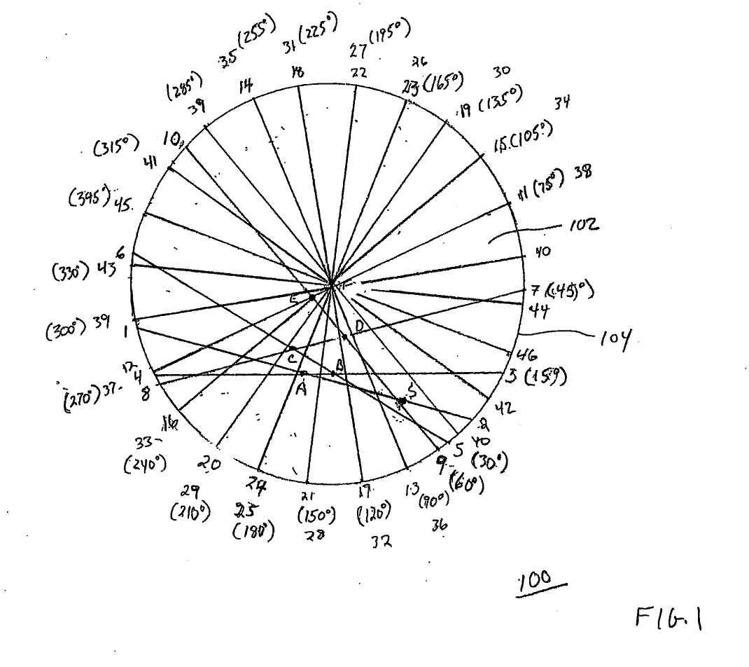

When the robot reaches the predetermined point, the robot turns in a first direction (e.g., counter-clockwise, or to the left) at a predetermined angle from the previous path and travels forward until it reaches a first wall. The robot then reverses direction, resets the counter to zero and begins traveling and counting until it reaches an opposing wall. Once the opposing wall is reached, the counter is stopped, and the robot reverses direction and travels along the reverse path until it reaches the predetermined point, in this example defined as 50% of the travel time along the immediately preceding path. At the predetermined point of this second path, in one embodiment where a power cable is coupled between the robot and an external power source, the robot turns in an opposite (second) direction from the first direction (e.g., clockwise, or to the right) the predetermined angle plus an incremental angular value. In a preferred embodiment, the incremental angular value is a multiple of the predetermined angle. The cleaner continues in this manner to find the predetermined point of the previously traveled path, alternately turning in a direction (left to right to left, and so on), and at an angle that is incrementally increased from the previous angle turned. Thus, the robot finds the hypothetical center of the pool, and cleans along radial paths spaced at predetermined angles as measured from the prior turn angle. The predetermined angles are selected based on the geometric considerations of each situation, including the width of the pool cleaner and its cleaning swath, to provide substantially complete cleaning coverage of the bottom surface of the pool in the most efficient manner possible Reference is now made to FIG. 1 which illustrates an example of a path traveled by a pool cleaning robot in accordance with a preferred embodiment of the present invention. In order to facilitate an understanding the invention, a circular pool 100 is shown, although the present invention is applicable in any shaped recreational aquatic environment. It is noted that each line represents the directional path of travel by the robot, and the lines are sequentially numbered along the circumference of the pool in order to show the direction of travel and the order of paths as they were traveled. In some instances the same path can be traveled repeatedly during the cleaning process, as noted by the dual references around the circumference of the pool. FIG. 1 also includes an incremental turn angle, as shown parenthetically.

A pool's bottom surface 102 having a circumscribing wall 104 is shown. For purposes of understanding the invention, cleaning of the sidewall 104 is omitted from the process. The cleaning robot arbitrarily and illustratively starts at point “S” located in the lower right quadrant of the pool, and proceeds to travel along a path until it reaches the wall 104 at point 1. The robot reverses direction along the same path and contemporaneously counts until it reaches an opposing wall at point 2. The robot resets the counter to zero, reverses travel direction and travels along the same path for one-half the time it traveled between the walls to bring it to a predetermined point, illustratively, the midpoint of the path 1-2. For example, if the time traveled between the opposing walls is forty seconds, then the midpoint is located approximately twenty seconds of travel time between the walls. This first midpoint designated as point A in FIG. 1 represents the midpoint between the path 1-2.

At point A, the cleaner turns in a first direction, e.g., clockwise (CW) or counter-clockwise (CCW) through a predetermined angle. The initial direction of turning is programmed into the algorithm, and in one embodiment, the pool cleaner will turn in alternate directions each time it comes to a midpoint in a path. Thus, if the initial turn direction is CCW, then the next turn is CW, followed by a CCW turn, followed by a CW turn, and so forth. Alternating directions is preferable in instances where the robot has a power cable coupled to an external power source. By alternating directions, the twisting of and build-up of the stress in the power cable is avoided, along with its attendant interference with the programmed movement of the cleaner.

The predetermined angle is an angle that optimizes the efficient cleaning of the surface of a pool with minimal or no overlap of path crossings as the robot traverses each path.

In one embodiment, the turn angle is in a range of approximately ten degrees to thirty degrees (10° to 30°), and is preferably fifteen degrees (15°). As will be apparent to one of ordinary skill in the art, the turn angle is based on the width of the cleaning robot, and more specifically, the width of the bottom surface of the cleaning brushed and/or the effective intake zone as the cleaner passes over the bottom surface of the pool 100. For illustrative purposes, FIG. 1 depicts a pool cleaner that is programmed with a turn angle of fifteen degrees.

At point A, the robot turns 15° counter-clockwise (left) and advances until it reaches a wall at point 3. The robot then reverses direction, starts the counter, and travels away from point 3 in the opposite direction until it encounters an opposing wall at point 4. The cleaner then reverses direction again and advances along until reaching the midpoint which is generally along path 4-3, illustratively shown as point B. It is noted that the robot cleans the surfaces over which it travels on all the paths.

At point B, the robot turns in the direction opposite to the previous turn. In this example, the robot turns clockwise through angle that equals the predetermined angle plus an incremental step. In this instance, the incremental step is the angle from the previous turn angle, while the total turn angle is the previous turn angle plus the predetermined angle. In the example of FIG. 1, the robot turns 15 degrees (previous turn angle) plus 15 degrees (predetermined angle) for a total of 30 degrees CW. The robot advances until it reaches the wall at point 5. The cleaner reverses direction, starts counting until it reaches the opposing wall at point 6. The cleaner finds the midpoint along path 5-6 at point C, where it either completely stops or begins a turn.

At point C, the robot turns CCW at an angle of 45° (i.e., 30°+15°) and travels along path 7-8 to find a new midpoint at point D. At point D, the robot turns CW at an angle of 60° (i.e., 45°+15°) and travels along path 9-10 to find a new midpoint at point E, where the robot turns CCW at an angle of 15 (i.e., 60°+15°) and travels along path 11-12 to find a new midpoint at point F. At point F, the robot turns CCW at an angle of 90° (i.e., 75°+15°) and travels along path 13-14. In this instance, the midpoint remains at point F for the remainder of the routine. That is, the robot has found the true center of the round swimming pool 100. The cleaner continues through alternate turning directions of increasing the turn angle as it travels along the bottom of the pool, until all or substantially all of the bottom of the pool has been cleaned.

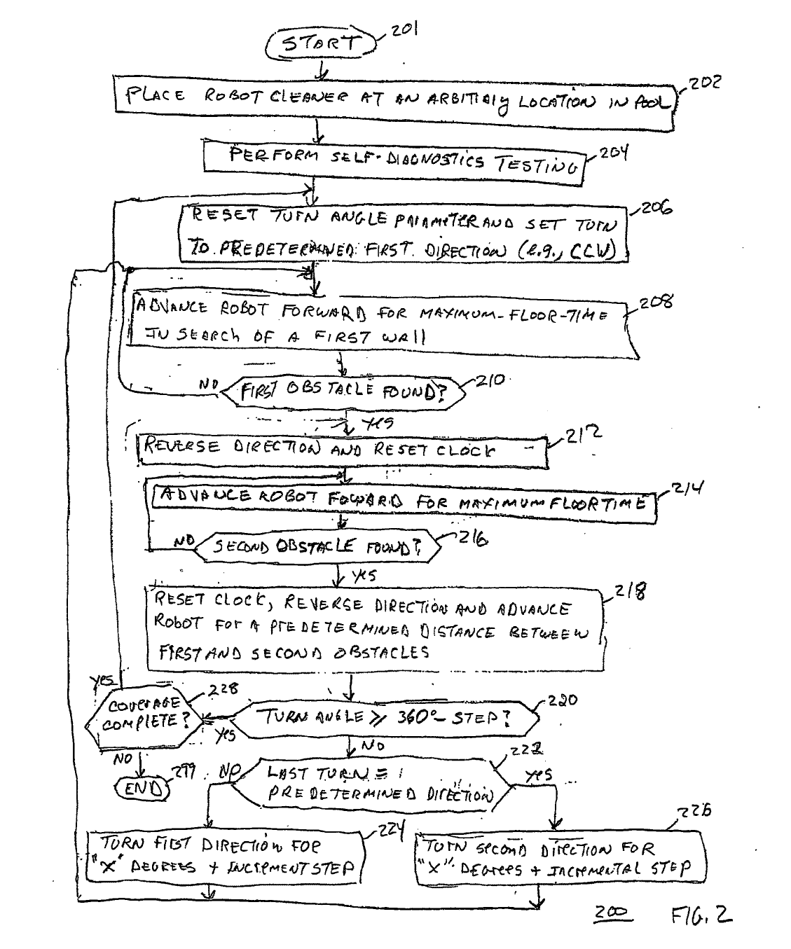

FIG. 2 is a flow diagram of a method 200 for cleaning a pool 100 by the pool cleaning robot in accordance with the present invention. Method 200 is to considered in conjunction with FIG. 1. Method 200 starts at step 201 and proceeds to step 202, where the pool cleaning robot is placed in the swimming pool to perform a cleaning operation. The robot can be placed at any location in the pool, as the cleaner is programmed to find a predetermined point (e.g., midpoint) between opposing walls and proceed with the operation based on locating this point. Thus, the cleaner can be placed arbitrarily into the aquatic environment 100. The method 200 then proceeds to step 204.

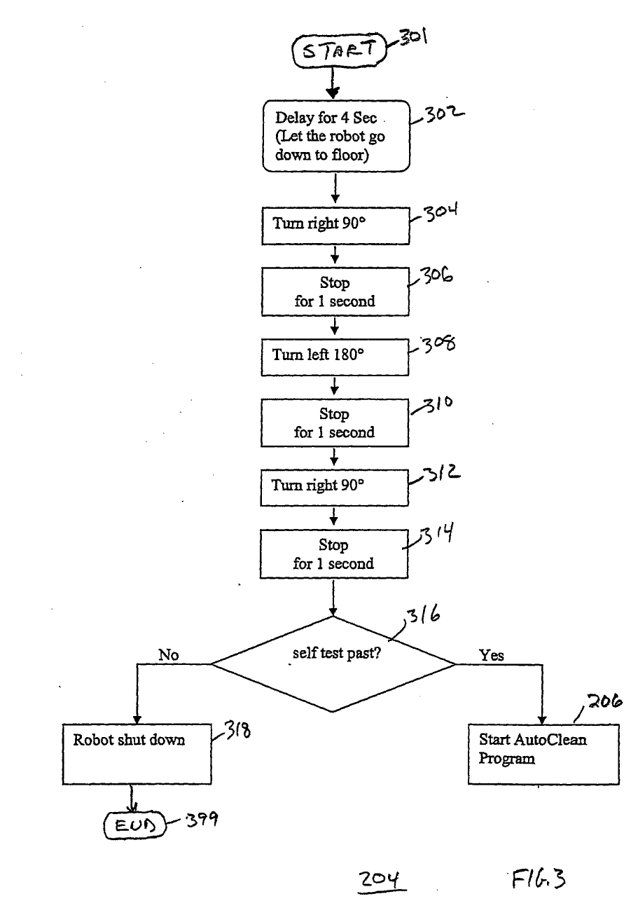

In the preferred embodiment of step 204, the robot performs a self-diagnostics test. The self-diagnostics test determines whether the robot is operational and ready to perform the cleaning routine of the present invention. Referring to FIG. 3, the self-diagnostics test 204 starts at step 301, and proceeds to step 302, where the robot sinks to the bottom of the pool 100. Time is allowed for the robot to settle to the bottom where portions of the robot, such as the filter bag, water pump, and the like fill with water prior to performing the self-diagnostic testing. In one embodiment, the robot remains stationary for approximately four seconds, although such time is not limiting. The method then proceeds to step 304.

At step 304, the robot turns right or clockwise for ninety degrees (90°), and at step 306, stops for one second. At step 308, the robot turns left or counter-clockwise for one hundred and eighty degrees (180°), and at step 310, stops for one second. At step 312, the robot turns right (CW) ninety degrees, and at step 314, stops for one second to place the robot back in its original position. It is noted that the time duration of the stops and the turn angles are not to be considered as being limiting.

As shown in step 316, if the robot failed to execute the proper turn angle, or failed to stop, or stopped for a predetermined time longer than one second, method 204 proceeds to step 318, where the self-diagnostics test is deemed to have failed. The robot will then shut down and the method 204 will end at step 399. However, upon successful completion of the self-diagnostics test, the method 204 proceeds to step 206 of method 200 (FIG. 2) to start the autoclean program. In an especially preferred embodiment, an audible and/or visual signal is initiated to alert the user of a failure. The signal can be sent from the submerged pool cleaner via the power cable to the power supply to activate an alarm to alert the user.

Referring to FIG. 2, at step 206, the turn angle parameter is set to zero, and the turn direction is set to a first direction, illustratively counter-clockwise. Referring to FIG. 1, the robot is at point S and will move in a first direction, arbitrarily designed as “forward” for purposes of this description. The method 200 then proceeds to step 208.

At step 208, the robot advances forward for a maximum floor time (MFT) until it encounters a first obstacle (i.e., wall). A timer associated with the controller of the robot keeps track of the elapsed time. The MFT represents a maximum travel time that the robot is allowed to travel in a particular direction without eventually contacting a wall. In one embodiment, the MFT is set to ninety seconds, although such time is not to be considered limiting. Rather, the MFT is based on the size of the pool. Accordingly, a larger MFT can be set for larger sized pools and vice versa.

If at step 210, an obstacle (e.g., a wall) has not been found, the robot continues to advance in the forward direction until either a wall has been reached or the MFT has elapsed. In the instance where the first wall has been reached or the MFT has elapsed without reaching the first wall, at step 212, the robot reverses direction and resets the counter. At step 214, the cleaner advances forward and contemporaneously counts along the path of travel with the travel time limit again being the illustrative 90-second MFT.

Referring to FIG. 1, the robot is shown having traveled from point S to point 1. Point 1 represents either the first wall, or the location where the MFT has elapsed. For purposes of understanding method 200 and for convenience, the method is described in terms of having reached a wall at the end of each path. However, it is to be understood that the each of the points along the circumference of the pool can alternatively represent a point where the MFT has elapsed, and if so, would necessitate that the MFT setting be increased to optimize cleaning of the entire pool surface.

At step 216, if a wall has not been reached or the MFT has not elapsed, the robot continues to advance until either a wall is reached or the MFT has elapsed. Assuming at step 216, a second wall has been reached at point 2 of FIG. 1, the method proceeds to step 218. At step 218, the counter is reset and the robot reverses its direction. The robot then advances in the forward direction in a substantially straight line for a predetermined distance between the opposing walls at points 1 and 2.

In one embodiment, the predetermined distance is based on the time of travel along a path between walls as counted by the counter. Preferably, the predetermined distance along the path is its midpoint, which is found by the robot by counting to half of the total count between the walls. For example, if the travel time between points 1 and 2 is forty seconds, then the midpoint, as represented by point A in FIG. 1, is approximately twenty seconds of travel time starting from the second wall at point 2. The predetermined distance is optimally set at the midpoint between the paths to provide the most efficient cleaning pattern in terms of total time to perform the cleaning operation and cleaning coverage (e.g., greater than 90%).

Once the robot is at the predetermined point in the path (e.g., the midpoint), the method 200 proceeds to step 220, where a determination is made whether the turn angle is greater than or equal to three hundred and sixty degrees (360°. Step 220 is provided to determine if the routine should end or be restarted with a different turn angle setting, as will be explained below in further detail.

If the total turn angle is less than 360°, then the method proceeds to step 222, where a determination is made whether the last turn is the same as the predetermined direction. If the last turn was not in the same direction as the predetermined or previous direction, then at step 224, the robot turns in the direction of the predetermined direction. For example, if the predetermined direction is CCW and the last turn by the robot was CW, then at step 224, the robot turns in the predetermined direction (e.g., CCW).

If the last turn by the robot is the same as the predetermined direction, then the method 200 proceeds to step 226. At step 226, the robot turns in the opposite direction to that of the predetermined direction (e.g., CW). Steps 222 through 226 are provided to force the robot to turn in alternating directions each time a new path is initiated during the cleaning process. Alternating the directions of the turns between CCW and CW helps prevent excessive stresses occurring on the power cable, as well as undesirable entanglements commonly found in those cleaners that do not alternate their directions of rotation.

In either of steps 224 and 226, the turn angle is equal to the predetermined turn angle plus an incremental step, which in one embodiment, is a multiple of the predetermined turn angle. The incremental step begins at zero and the multiple sequentially increases thereafter, for example, 0, 1, 2, and so forth. Referring to FIG. 1, the robot is at point A. There was no previous last turn, so at step 222, the last turn equals the predetermined step. Thus, the robot turns CCW at a turn angle of 15° plus a zero degree incremental step, and the method proceeds to step 208.

At step 208, the robot advances forward illustratively within the MFT and at step 210 encounters the wall at point 3. At step 212, the robot reverses, and at step 214 advances illustratively within the MFT until at step 216 reaches the wall at point 4. At step 218, the counter is reset, the direction of the robot is reversed, and the robot advances to the predetermined distance (e.g., midpoint) between along the path 34, which is shown by point B.

At step 220, the turn angle is less than 360°, and the method 200 proceeds to step 222, where the last turn direction is identified as being CCW, which is the same as the predetermined direction. The method proceeds to step 226, where the robot turns CW at a turn angle of 300 (15°+15°). The method 200 then proceeds to step 208, where the routine is repeated, as discussed above with respect to FIG. 1.

Each time a new path is traveled, preferably, the midpoint is used as a predetermined point to start the direction (i.e., turn angle) of a new path. Eventually, the robot will determine a central point for the shaped pool, such as point F, and travel along paths that overlap at the center point, but are spaced apart approximately equal to the width of the robot proximate the walls (i.e., circumference of the circle). Referring to FIG. 1, the distance between any adjacent points along the circumference (e.g., points 22 and 23) approximately equals the width of the robot In the illustrative example, twenty three paths ((360°/15°)−1=23) were required to clean the entire bottom surface.

Referring to FIG. 2, at step 220, if the turn angle is greater than or equal to 360°, then the pool cleaner will begin to clean the pool again along a majority if not all of the previous paths. Accordingly, the method 200 proceeds to step 228, where a determination is made whether a predetermined amount of the pool has been cleaned by the robot during the first complete performance of the algorithm. Preferably, the predetermined amount that the pool has been cleaned during one complete performance is at least 95%.

If the determination is affirmatively answered (i.e., 95% coverage) then the method proceeds to step 299, where the method 200 ends. However, in the unlikely event where the length or diameter of the pool is large enough to cause non-cleaned gaps between the paths of travel by the robot, the method 200 proceeds 510 step 206. For example, a center portion of surface between adjacent points 22 and 23 may have not been traversed and cleaned by the robot because the robot is not wide enough to cover the center portion between the adjacent points proximate the wall. The present invention overcomes the robot width constraint by returning to step 206, where the turn angle is reset to a new value, and the algorithm is run for a second time.

For example, on the first complete pass discussed above, the predetermined turn angle was set to 15°. During the second run of the cleaner, at step 206, the predetermined turn angle can be set to some other value, such as 20°, or any other value that will increase the overall cleaning coverage after two complete passes. Accordingly, steps 228 and 206 enable the robot to execute the routine a number of times (e.g., twice) with different turning angles in an instance where greater pool cleaning coverage is desired.

In one embodiment, the turning angle is incremented by approximately a half of the previous turning angle. For example, the 15° turning angle would be increased to 22°. However, using a half value of the previous turn angle as an increment should not be considered as being limiting.

Variations in the travel paths of the robot can also be accommodated by the routine discussed with respect to FIG. 2. For example, it is often desirable for the cleaning robot to clean the sidewalls 104 of the pool 100 in addition to the bottom surface 102. Cleaning robots that clean the sidewalls 104 of the pool are conventionally known in the art. For example, commonly assigned U.S. Pat. No. 6,099,658 to Porat discloses a robot for cleaning the bottom and vertical side walls of a swimming pool. The method of the present invention can also be adapted to clean the vertical sidewalls 104 or sloped and/or curved surfaces of a pool.

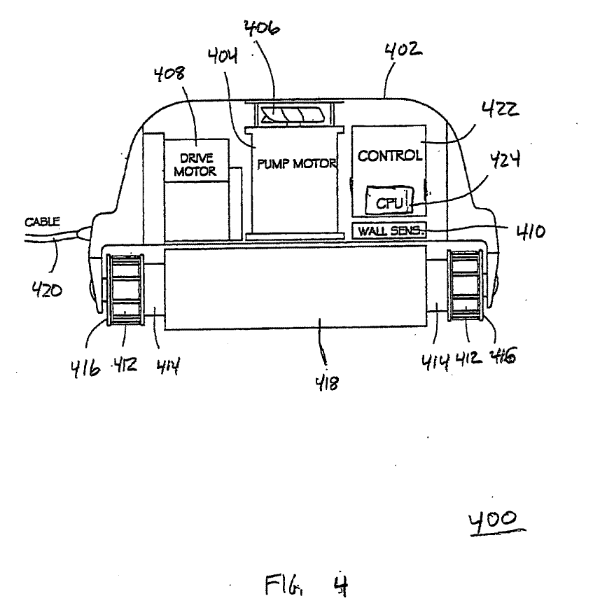

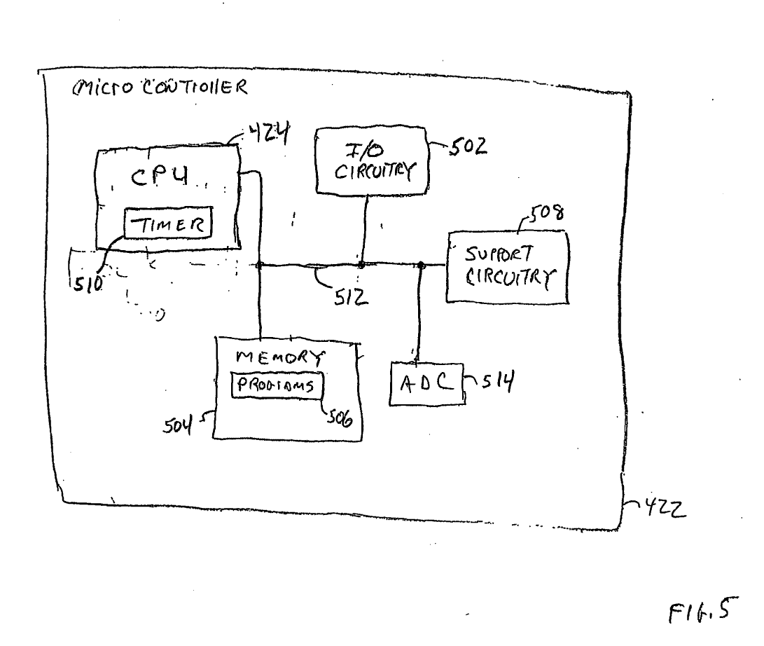

As discussed below with respect to FIGS. 4 and 5, the robot is equipped with sensors that identify a wall and/or the surface of water as the submerged robot approaches the surface along a sidewall. In this instance, the robot regards the surface of the water as a wall, and method 200 finds the predetermined point (e.g., the midpoint) between the surfaces of two opposing walls. That is, the robot reaches a first wall, climbs up the wall to the water surface and reverses direction until it reaches a second wall. The robot then climbs the second wall and counts the time to travel between the surface proximate the first wall and the surface proximate the second wall. The midpoint there between is then located using the counter, and the robot will turn according to the predetermined turn angle and proceed as described above. In this manner, both the bottom surface and side walls are cleaned using method 200.

As described with respect to FIG. 1, the robot reaches or comes into contact with each wall and reverses itself along the same path. However, the curvature of the wall may make it impractical or undesirable for the robot to reverse itself and follow along the same path that it approached the wall.

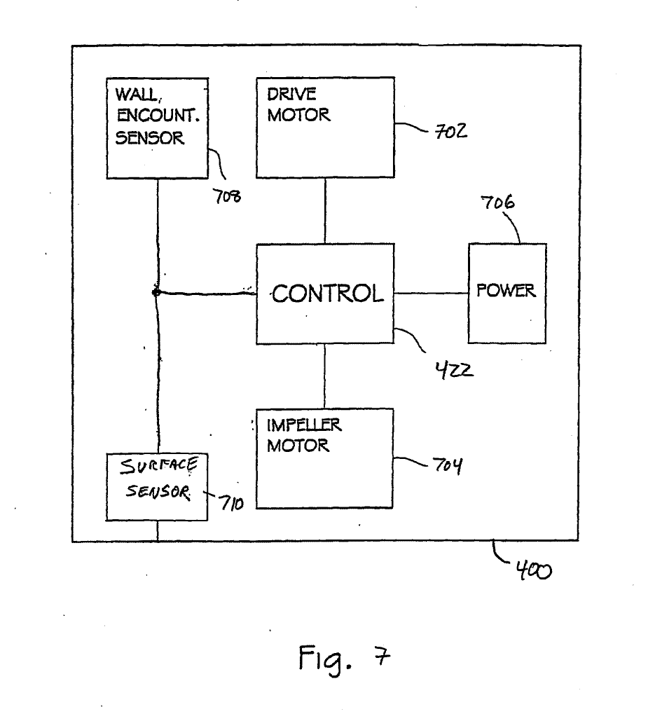

Referring to FIG. 6, an alternative embodiment of the invention is shown. The pool is circular as shown in FIG. 1, and the path taken by the robot after being placed at an arbitrary position in the pool causes the robot to reach the wall at an angle to the wall, as opposed to being perpendicular to the wall. The robot 400 is arbitrarily placed at point S, and proceeds along path 602 until it reaches the vertical wall 104. Upon reaching the wall, the left side of the robot comes into contact with or proximate to the wall first, as illustratively shown by contact point 1. In this alternative embodiment. The robot illustratively includes a motor-driven caterpillar drive (but other drive types are possible too) and the left drive (wheel) stops turning, while the right drive continues to turn until the right drive is also in contact with or proximate to the wall at contact point 2, and accordingly, the robot is substantially perpendicular with the respect to the sidewall 104. The robot then proceeds forward along path 604 until it reaches a second wall, illustratively at point 3. As discussed above, the counter contemporaneously counts as the robot travels along the path 604 between opposing walls, and determines the midpoint from the count. The robot reverses itself and travels from the second wall to midpoint, as shown by point A.

Comparing the paths of FIGS. 1 and 6, the robot 400 in FIG. 6 will find the center of the circular pool by traveling along a single path. By comparison, the robot in FIG. 1 must travel along five paths before the final midpoint F of all the subsequent paths is located. As illustrated herein for a circular pool, the robot of FIG. 6 travels along a lesser quantity of paths, and accordingly, takes less time to clean the circular pool.

A pool cleaning robot in accordance with a preferred embodiment of the present invention may be any such robot adapted to perform the navigational algorithm of the present invention.

Reference is now made to FIG. 4, which illustrates a sectional view of a pool cleaning robot 400 in accordance with the present invention. A robot housing 402 houses a motor drive 408 for driving the axles 414 (in axle cover 418) on which ends wheels 416 are attached to the caterpillar tracks 412, an impeller 406 oriented horizontally (to pump water from the pool's floor upwards into the robot) and driven by a pump motor 404, a control unit 422 having a processor (e.g., central processing unit (CPU)) 424, and at least one wall and/or surface encounter sensor 410. The pumped dirt and foliage are collected inside a filter bag (not shown) that is positioned inside the housing along the pump 404.

A power cable 420 extends through the housing 402 to provide power to the robot's electrical components. In other preferred embodiments of the present invention the power cable 420 is not present, and instead the robot is powered by battery (not shown).

The robot 400 shown in FIG. 4 is driven by a single motor (drive motor 404). Usually pool cleaning robots targeted for small and medium sized pools are provided with a single motor drive, whereas a twin motor drive is popular in large pools cleaning robots. A single motor drive can be reversed to reverse the direction of the rotation of the wheel axles, but it cannot be used to turn the robot sideways. It takes two separate motors to maneuver sideways, as each track is operated separately, either by stopping one track and driving the other, or by pirouetting (driving tracks in opposite directions). In order to make a single motor robot turn sideways, in one embodiment, a series of intentional interrupts in the impeller rotation can be employed, thus causing the robot to acquire bias momentum directed sideways, and hence move in that direction. This method takes advantage of the fact that impellers are inherently biased and a series of imparted interrupts in the impeller rotation can cause the robot to acquire momentum directed sideways. For a detailed understanding of turning the robot using the impeller, the reader is directed to U.S. Publication No. 2004/0021439, the contents of which are incorporated by reference herein.

FIG. 5 illustrates a schematic diagram of the functional features of a microcontroller of the pool cleaning robot 400 in accordance with the present invention. Specifically, FIG. 5 depicts a high-level block diagram of a microcontroller 422 suitable for use in the illustrative pool cleaning robot of FIG. 4. The illustrative components of the microprocessor illustrate functional aspects of the controller that can be performed by either hardware components, software or a combination thereof.

The microcontroller 422 comprises a central processing unit (CPU) 424, which provides core processing functions, as well as memory 504 for storing various control programs 506. The memory can include any volatile and/or non-volatile memory, such as RAM, ROM, PROM, EEPROM, flash memory, among other memory devices conventionally known in the art.

The processor 424 cooperates with conventional support circuitry 508, such as power supplies, counter circuits, cache memory and the like, as well as circuits that assist in executing the software routines (i.e., programs) 506 stored in the memory 504. As such, it is contemplated that some of the process steps discussed herein as software processes may be implemented within hardware, for example, as circuitry that cooperates with the processor 502 to perform various steps.

For example, in the embodiment of FIG. 4, the microcontroller 422 optionally communicates with one or more counters, such as counter 510, which counts the time taken for the robot to traverse along a particular path. The processor 424 executes commands from the programs 506 (e.g., method 200) to start, stop, or reset the counter, as well as perform diagnostics and navigate the robot according to method 200 of the present invention.

The microcontroller 422 also contains input/output (I/O) circuitry 502 that forms an interface between the various functional elements communicating with the controller 422. In one embodiment, a universal serial bus (USB) is coupled to the I/O interface circuitry 502 to enable installation of routine 200 into memory (e.g., flash memory) 504 by the manufacturer or a vendor of the robot. The CPU 424, memory, 504, support circuitry 508, timer 510, and I/O circuitry 502 of the controller 422 communicate with each other along at least one bus 512.

In addition, an analog/digital converter (ADC) 514 converts analog signals received from the I/O circuitry 502 for processing by the CPU 424 and/or storage in memory 504. Such analog signals can originate from the various sensors incorporated into the robot, such as a mercury switch for sensing the horizontal or vertical orientation of the cleaner, or other sensors for detecting the presence of an obstacle, such as a wall of the pool.

Although the microcontroller 422 of FIG. 4 is depicted as a general-purpose computer that is programmed to perform various control functions in accordance with the present invention, the invention can be implemented in hardware such as, for example, an application specific integrated circuit (ASIC). As such, it is intended that the processes described herein be broadly interpreted as being equivalently performed by software, hardware, or a combination thereof.

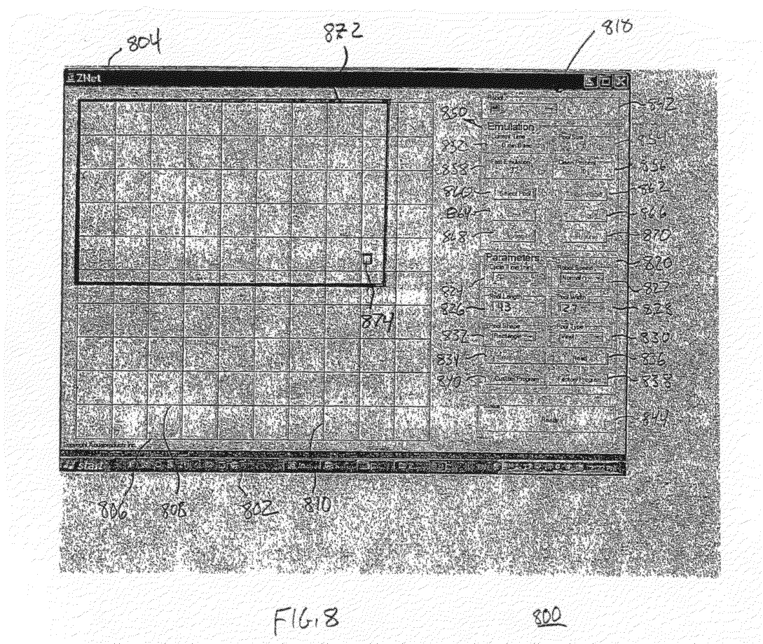

Referring to FIG. 7, a schematic block diagram of the electrical features of the pool cleaning robot is shown. The pool cleaning robot 400 comprises a reversible drive motor 702 and impeller motor 704 that are independently controlled by the controller 422. The robot is powered by power supply 706, either externally through a cable 420 or internally by battery. The controller 422 dictates the operation of the control and consequently of the entire robot 400. The robot has a wall encounter sensor 708 that senses a wall encounter and generates a signal that is received by the processing unit 424. Optionally, the robot can include a surface encounter sensor 710 (e.g., a gravity sensor) that senses the water surface after climbing a wall and generates a signal that is received by the processing unit 424 of the controller 422.

It is noted that the event of encountering a wall can be sensed by a sensor provided on the robot, such as a proximity sensor or collision sensor, or sonar sensor, and the drive motor of the robot is switched to the reverse direction. For example, for that purpose a proximity sensor—an optical sensor typically operating in the infrared range—or a tilt sensor, such as mercury sensor—a sensor actuated by a balanced tiltable mechanism that senses the tilting of the robot as it attempts to climb a wall, can be used. If a sonar sensor is used, one can obtain better directional control as well.

The controller 422 is programmed to actuate the drive motor and impeller motor, via the processor 424, in a predetermined manner following an algorithm, such as method 200 as explained with reference to FIGS. 1-3 and 6. The controller 422 is also programmed to switch the drive motor 702 between forward and reverse modes, and optionally apply an interrupt sequence scheme to the impeller motor 704.

As will be apparent to one of ordinary skill in the art, if the pool cleaner approaches the wall at an angle, it will assume a position in which its longitudinal axis is normal to the wall and the pool cleaner will move away from the wall at an angle and along a path that is somewhat different than its approaching path. Such occasional and/or minor variations do not adversely effect the overall efficiency of the cleaning or coverage pattern of the method of the invention. Likewise, minor variations in the path caused by the drag of the power cable, the sloping bottom surface or surface irregularities, water outlet jets or intakes have a negligible effect, if any, on the overall superior efficiency of the method of the invention.

It is noted that the method and apparatus for automated pool cleaning of the present invention can be implemented on pools of any shapes, whether rectangular, polygonal, circular, oval and even irregularly shaped ones. The steps of determining the midpoint of each path between opposing walls, and then turning the robot at a predetermined angle ensures that substantially the entire pool floor is efficiently covered, and thereby cleaned in a relatively short time.

Variations of the location where the robot makes the angled turn can be varied, although the midpoint along the path between opposing walls is deemed an optimum location. TABLE 1 illustrates that the predetermined time between walls COW) where the robot makes its turn along each path traveled should be in a range between 30% and 70%. The data set forth in TABLE 1 was obtained by running computer simulations that correspond with actual tests performed by a robot in various shaped pools.

TABLE 1

| | Various Shaped Pools | | | |
|---|---|---|---|---|
| TBW Percent | Rectangle/Square | Ellipse | Kidney | Irregular/Custom |
| 30% TBW | 2.0 hrs. with 60% | 2.5 hrs. with 50% | 3.0 hrs. with 40% | 4.5 hrs. with 40% |
| | coverage | coverage | coverage | coverage |
| 40% TBW | 1.5 hrs. with 85% | 2.0 hrs. with 80% | 2.5 hrs. with 75% | 4.0 hrs. with 70% |
| | coverage | coverage | coverage | coverage |
| 50% TBW | 40 min. with | 50 min. with | 1 hr. with 100% | 1.2 hrs. with |
| | 100% coverage | 100% coverage | coverage | 100% coverage |
| 60% TBW | 1.5 hrs. with 85% | 2.0 hrs. with 80% | 2.5 hrs. with 75% | 4.0 hrs. with 70% |
| | coverage | coverage | coverage | coverage |
| 70% TBW | 2.0 hrs. with 60% | 2.5 hrs. with 50% | 3.0 hrs. with 40% | 4.5 hrs. with 40% |
| | coverage | coverage | coverage | coverage |

TABLE 1 illustrates that the midpoint (i.e., 50% TBW) is the optimal position to turn the robot at the predetermined turn angle in alternating CW and CCW directions. If the robot is programmed to turn at its predetermined turn angle (e.g., 15°), for example, in a rectangular pool approximately one third (30%) of the way along a given path, only 60% of the pool will be cleaned in a 2 hour period. By contrast, if the robot turns at the midpoint (50% TBW) between opposing walls in the same rectangular pool, the robot will clean 100% of the bottom surface of the pool in only 40 minutes. TABLE 1 also shows similar results for other pool shapes, and clearly indicates that the optimal point for pools of all shapes is midway along the path between opposing walls.

One particular advantage of the robot of the present invention is the ability to clean an entire pool in an expeditious manner. The method of the invention is applicable to a pool of any shape, and avoids having to create and run programs for different shaped pools. In one embodiment, the robot is programmed by the manufacturer for any pool shape having a maximum distance of thirty (30) feet between opposing walls. The illustrative thirty foot maximum length is based on the width of the robot being approximately twenty (20) inches wide. By programming the cleaner with such maximum limit, the cleaner need only perform the cleaning routine (i.e., method 200) one time. However, one skilled in the art will appreciate that the maximum length can vary depending on the width of the effective cleaning path of the unit. For example, a robot having a cleaning width of approximately, forty inches can cover a pool having a length of approximately two hundred feet. A conventional robot has a width in the range of 16 inches to 40 inches. Although such dimensions are not to be considered as limiting.

In yet another embodiment, an electrical current detection sensor and shut-off switch (not shown) are provided in the control circuit to turn the cleaner off in the event that the robot is trapped or becomes entangled in the power cord for a predetermined period of time. The current detection sensor samples the magnitude of the current loading of the drive motor, for example, 50 times every three seconds, and sends the information to the controller, which takes an average of the samples for comparison to a threshold value. The threshold value is set based on the specific type of the pool surface. For example, the high friction of a gunnite surface will induce a greater current load on the motor than a smooth vinyl or glazed tile surface. As will be apparent to those of ordinary skill in the art, should the pool cleaner brushes be rotating while the cleaner is not advancing, the frictional forces will produce an unusual load on the drive motor.

If the last-sampled current load exceeds the threshold value, for example, by a predetermined percentage, then the controller deactivates the drive motor. In one embodiment, only the last current average sample is used for comparison to a predetermined threshold value. That is, a predetermined threshold value is programmed into the controller for comparison purposes. It is noted that the current magnitude sampling sensor can be provided with circuitry for computing and/or comparing the sampled values and threshold values. In this embodiment, the current detection sensor sends a signal to the controller to interrupt the current to at least the drive motor to deactivate the robot.

In another embodiment, the current detection sensor can store (or send to the controller for storage) one or more previous average current values. The one or more previous average current values can be used as the threshold value, such that the latest acquired average current value is compared to the previous value(s). If there is a sharp rise in the latest acquired average current value (e.g., greater than 10%), then the current detection sensor will send a signal to the controller to deactivate the robot, as discussed above.

Referring to FIG. 8, a graphical user interface (GUI) 804 corresponding to a pool cleaning emulation and robot configuration program of the present invention is illustratively presented on a display panel or monitor 800. The GUI 804 is presented to the user on the display 800 by executing the pool cleaning emulation and robot configuration program from a remote computer. The program is an application program that can be installed on a computer device. such as a laptop computer. Preferably, the program operates in a windows format in a conventional manner on top of the operating system 802 installed on the computer, such as a WINDOWS operating system.

As described above the pool cleaning algorithm disclosed with respect to FIGS. 1-7 is installed in the memory 504 of the microcontroller 422 of the robot 400. The pool cleaning emulation and robot configuration program that is installed on a remote computer, as described with respect to FIG. 8, is a different and distinct program from the pool cleaning algorithm program of the robot 400.

As the name of the program implies, the pool cleaning emulation and robot configuration program serves dual functions: it can be used to demonstrate how a robot 400 would clean a pool having a conventional or custom shape, as well as download user customized or preferential program parameters to the robot 400. The customized program parameters replace the factory default parameters in the pool cleaning program stored in the microcontroller 422 of the robot 400. The emulation portion of the program can be executed and run without having a connection to a robot. Accordingly, it is only necessary to connect the robot 400 to the remote computer device when the end-user wishes to download particular programming parameters to the microcontroller 422 of the robot 400.

The GUI 804 includes a grid 806 formed by a plurality of horizontal and vertical lines 808 and 810, and is presented proximate the center and left side of the display 800. The grid 806 is used to illustrate (i.e., draw) the peripheral shape of a pool 872. The grid 806 is scaled such that each box formed by the horizontal and verticals lines a predetermined number of feet, i.e., squares five feet on a side. As depicted, the illustrative grid 806 includes ten rows and ten columns of boxes (i.e., 10×10 grid), representing 2,500 square feet. The scaling of the program 804 can be adjusted as required to accommodate pools of different sizes and shapes.

On the right side of the display, the user is presented with a control section 818 for providing particular control information. The control section 818 includes a parameter options section 820, an emulation options section 850, a robot model field 842, and a status field 844. The control section 818 of the GUI 806 enables a user to select various pool parameters to draw a representation of the pool on the grid 806, as well as perform a pool cleaning emulation on the display for a particular cleaning robot model. That is, the program 802 can create an image of a pool on the grid, insert a representation of a particular robot model in the pool image, and then emulate how the pool cleaning algorithm discussed above with respect to FIGS. 1-7 would actually perform the cleaning operation in the pool depicted on the display.

The pool parameter section 820 includes a robot speed option 822, a cycle time option 824, a pool length field 826, a pool width field, 828, a pool type field 830, a pool shape field 832, a search robot option 834, a read option 836, a factory program option 838, and a custom program option 840.

The pool shape option 832 allows a user to select a conventional pool shape that will be drawn on the grid 806. The user can click on the pool shape button 832, illustratively using a mouse, to select conventional pool shapes such as rectangular, oval, kidney, L-shaped, and Roman shaped pools. Once the pool shape is selected, the user can type in the dimensions in the length and width fields 826 and 828.

As shown in FIG. 8, a rectangular shape is selected and a rectangular box is displayed in the upper left corner to illustrate the periphery, i.e., the walls, of the selected pool. The drawing of the pool is sized according to the scale of the grid. The length and width parameters 826 and 828 enable a user to enter the maximum length and width of the pool shape.

Alternatively, if a shape is not provided in the pool shape list, the user is provided with an option to draw a custom-shaped pool on the grid. The custom shape pool can be drawn by using a mouse to form the periphery of the illustrative pool. When drawing a custom shape, the pool dimensions are automatically added, depending on the placement of the lines representing the pool walls in the grid.

The user can select the type of surface material of the pool from the pool type field 830. The surface of the pool influences the types of cleaning brushes attached to the bottom of the cleaning robot 400, as well as the speed in which the robot will travel along the pool surfaces. Therefore, the dealer or end user can personalize the robot to meet the user's needs, as well as provide visual electronic simulations on a computer monitor to predict the amount of time that it will take for the robot to clean all, or substantially all of the pool.

The types of surface can include vinyl, gunnite, ceramic tile, fiberglass or a customized surface. Selection of the proper surface is important in the operation of the robot, since the different types of surfaces will have different coefficients of friction. Accordingly, robot movement and turning will be different depending on the surface of the bottom and the side walls of the pool.

Additionally, the drive motor current load will also be influenced by the type of pool surface. In one embodiment, the robot uses the chive motor current to detect a wall when the robot is unable to climb a wall or obstacle. The robot computes the drive motor current by taking samples to derive an average current, and then comparing the average current to a predetermined threshold value. The predetermined threshold value is set by the selection of the type of pool surface where, for example, the threshold value is lower for a vinyl surface as compared to threshold value for a gunnite surface, since the coefficient of friction for a vinyl surface is less than that for a gunnite surface. Accordingly, the proper surface must be chosen for the program to most accurately emulate the robot cleaning the pool.

The robot speed option 822 allows a user to select, illustratively, between normal, slow, fast and undefined speeds. The speed of the robot affects the cleaning ability of the robot. In particular, the slower the robot moves, the more effective the robot is in scrubbing and drawing up debris. Faster speeds may cause the robot to stir the debris around beneath the cleaner and not draw up as much debris along the path. The slow speed can be selected when the pool has not been regularly cleaned and there is more debris present. Conversely, if the pool is relatively clean and the user wants to give the pool a quick clean, then the fast speed can be selected.

The cycle time field 824 allows a user to select a specific time (e.g., minutes) during which the pool cleaner will perform its cleaning operation. Although the robot is advantageously designed to operate unattended, the user has an option of operating the cleaning program for a predetermined time. This timing option is advantageous in instances where the user is leaving their house in a short time (e.g., an hour) and wants to get a quick cleaning done before the user departs, and without the user leaving the robot on unattended thereafter.

The emulation section 850 allows a user to emulate the paths the robot will follow to clean the pool. The emulation of the paths is shown in the pool representation drawn in the grid 806. The emulation section 850 includes a current time field 852, a pool size field 854, a clean percent field 856, a fast emulation field 858, a select pool field 860, place robot button 862, a start button 864, a stop button 866, a pause button 868, and a resume button 870.

In one embodiment, the user inserts the representative robot 874 in the pool 872 drawn on the grid 806 by pointing the mouse arrow at a desired start position in the grid 806 and then left clicking on the mouse button. Alternatively, the user can click on the Place Robot button 862 on the GUI for a default location. In FIG. 8, the robot 874 is illustratively shown as being placed in the lower right corner of the pool 872 in the grid 806.

The user can select a specific robot mode from among a list of models having different characteristics to compare their respective capabilities to clean a pool in accordance with the pool cleaning algorithm described above. The user can view the list by placing the mouse pointer at the arrow of the robot model field 842 and clicking to select one of the robot models. For example, pool cleaners having different cleaning widths, fast and slower speed options, turning methods, and times will perform differently. The emulation portion of the program allows the user to observe and compare performance differences between the models with respect to at least coverage and the time required to clean all or a specified percentage of the bottom surface of the pool selected

Pressing (i.e., clicking) the start button 864 on the GUI starts an emulation of the robot 874 performing a cleaning operation in the pool 872 that has been drawn on the grid 806. As the emulation program emulates the cleaning operation performed by the pool cleaning algorithm described in detail above, the time that it would take the actual robot to perform the cleaning operation is displayed. In other words, the time displayed emulates the actual time it would take for a robot to perform the cleaning operation. Further, the clean percent field 856 displays a numerical value representing the percentage of the surface of the pool currently cleaned by the robot 874.

The speed of the emulation can be increased by checking off the box in the fast emulation field 858. In one embodiment, the fast emulation option increases the emulation process by a factor of ten (10×), although such value is not to be considered as being limiting. The emulation can be stopped, paused, and/or resumed in a conventional manner by pressing the appropriate buttons provided in the GUI 806.

The pool size field 864 provides an indication of the area of the pool being cleaned. For example, the emulation program is capable of computing the area to be cleaned for a conventional shaped or custom configured pool that is drawn on the grid 806.

Although the robot 400 includes the pool cleaning algorithm preinstalled in the microcontroller 422 of the robot from the factory, various parameters of the pool cleaning algorithm installed in the robot 400 can be customized remotely. In a preferred embodiment, a vendor (e.g., dealer) of the robot 400 can provide custom programming of the robot based on the specific characteristics of the pool. Alternatively, the end-user can download the customized programming to the robot.

Referring to the parameters section 820 in FIG. 8, the dealer or end-user can program the robot 400 using the customized parameters entered in the parameter section of the GUI 806. The downloading of the parameters to the robot 400 can be performed without running the emulation or after the emulation has been either stopped, paused or completed.

During the download operation, the specific parameter information (e.g., values) is sent either directly or indirectly to the memory 504 in the microcontroller 422 of the robotic pool cleaner 400. In one embodiment, the robot is powered by an external power source, illustratively, located near the pool via a power cable. In one embodiment, a power supply communications line is also provided between the external power supply and the robot 400.

The power cable and communications cables 420 are preferably encased in a watertight protective covering and extend a length sufficient to permit the robot to travel unimpeded to the farthest reaches of the pool. The power supply communications line is coupled on one end to a USB port that is attached to the external housing of the power supply. The other end of the power supply communications line is coupled to an I/O interface on the robot 400 by hard wiring or a connector, such as a USB port.

To perform a downloading operation, the remote computer device is connected to the external power supply via a second communication line, for example, by using a conventional USB-to-serial (RS-232) adapter. The specific parameters are then sent via the second communications line to the external power source, which forwards the information to the microcontroller of the robot via the power supply communications line.

In another embodiment, the robot is powered locally, preferably by an on-board rechargeable battery. In this embodiment, the I/O circuitry 502 of the microcontroller 422 is advantageously coupled to an I/O interface, such as a USB port, located on the housing of the robot. A USB-to-serial adapter can be used to provide direct communications between the remote computer and the robot 400. The direct communication line is illustratively provided by connecting the RS-232 connector to the corresponding connector on the remote computer, and connecting the USB connector to a corresponding USB port located on the housing of the robot 400. Wireless communication links can also be established in accordance with devices well known to the art. For the purposes of describing the programming steps, cable connections will be utilized.

Advantageously, the communications adapter can be used for transferring information from the remote computer to the USB port located on either the external power supply or the housing of the robot, depending on the embodiment (i.e., model) of the robot. The communications adapter allows the dealer or end-user to use the pool cleaning emulation and robot configuration program installed on a remote computer to conveniently download customized parameters for use by the pool cleaning algorithm installed the robot.

Once the communication cabling connections are made, the dealer or end-user clicks on the “Search Robot” button 834 and checks the Status indicator 844 for indication that connectivity between the laptop and robot exists. In one embodiment, the status indicator 844 will provide a “Robot Found” message if connectivity is achieved. If the robot is not detected, in one embodiment, the status indicator 844 indicates that the laptop cannot connect to the appropriate port (e.g., COM 1). In this instance the user should check to see if the cable connections have been properly completed.

Once the status indicator 844 indicates that the robot 400 has been found (i.e., an exchange of protocols has been properly established), the user can program the robot 400 with the specific features by clicking the “Custom Program” button 840 in the parameter section 820. To initiate the downloading of the programming to the robot 400, the user clicks on the “Read” button 836, and the selected custom program variables are transferred from the interface on the external power supply (or directly from the laptop) to the robot 400 via the coupled communication lines.

In one embodiment, the user is provided with means for deactivating the customized programming to allow the robot to operate in accordance with the standard factory default algorithm to clean the surfaces of the pool. Such means for deactivating the program can include a toggle switch physically positioned on the robot 400. The pool cleaning emulation and robot configuration program also permits the user to operate using the default factory setting by communicating software commands to the robot by an end-user computer. For example, the robot can be programmed back to the factory default settings for that model by selecting the “Factory” program button 838 and initiating the communications via selecting the Read button 836. The pool cleaning emulation and robot configuration program transfers the factory default settings from the external power supply to the robot 400 via the communications cable coupled there between.

Once the custom program has been downloaded to the robot 400, the status indicator 844 in the GUI 806 displays an indication of successful programming, such as a “Robot Programmed Successfully” message. Audible messages can also be included along with sound effects, music and/or other audible features.

The pool cleaning emulation and robot configuration program of the present invention can be stored on any conventional memory device, such as a compact disk, flash memory, among other memory devices, and be installed on a computer device in a conventional manner. The custom or factory parameters from the pool cleaning emulation and robot configuration program can be downloaded from a laptop (as discussed above) to the cleaner upon executing proper authorizations. Other conventionally known techniques can also be utilized to download and install the program on a remote computer, such as downloading the emulation program from a server over a private network, such as an intranet of the dealer, or over a public network, such as the Internet. Thus, an end user having a particular shaped pool can have the dealer program the robot based on the shape and dimensions of the pool. In this manner, the purchaser receives personalized service from the dealer to ensure maximum cleaning coverage in the least amount of time.

Alternatively, an end-user can be provided with the capability to download the pool cleaning emulation and configuration program to their computer from either a portable memory device (e.g., CD) or a web server. Once the user installs the emulation and configuration program on a personal computer, the end user can then transfer specific pool parameters from the personal computer to the robot 400 either directly using the communications adapter or via the external power supply, depending on the model (i.e., location of the power source) of the robot, as described in detail above.

While the disclosed structure and apparatus have been particularly shown and described with respect to the preferred embodiments, it will be apparent to those of ordinary skill in the art that various modifications in form and detail can be made without departing from the scope and spirit of the invention. Accordingly, modifications such as those suggested above, but not limited thereto are to be considered within the scope of the invention, which is to be determined by reference to the appended claims.

What is claimed is:

1. A method for cleaning at least the bottom surface of a pool by a robotic pool cleaner having a drive means, the method comprising:
advancing the pool cleaner until it encounters a first obstacle;
reversing the drive means to move the pool cleaner away from the first obstacle along a first path to a second obstacle;
reversing the drive means at the second obstacle to move the pool cleaner along a second path to a predetermined position that is correlated to said first path;
turning the pool cleaner in a first direction through a predetermined angle;
repeating the above steps to move the pool cleaner along additional paths until a sum of said predetermined angular turns results in a quantity of paths sufficient to clean substantially the entire bottom surface of the pool.

2. The method of claim 1, wherein the first and second obstacles include opposing walls of the pool.

3. The method of claim 1, wherein the first and second obstacles include water surfaces proximate opposing walls of the pool.

4. The method of claim 1, wherein said first obstacle includes attaining a maximum elapsed time limit prior to the robot reaching a wall.

5. The method of claim 1, wherein the pool cleaner is initially positioned near a wall on the bottom surface of the pool.

6. The method of claim 1, wherein the predetermined angle of turn is determined based on the width of the effective cleaning path to provide maximum pool cleaning coverage.

7. The method of claim 1, wherein the first direction is either of counter-clockwise or clockwise.

8. The method of claim 1, wherein the predetermined point is located in a range of approximately 30% to 70% of the distance along the first path between said opposing obstacles.

9. The method of claim 1, wherein the predetermined point is located approximately 50% of the distance along the first path between said opposing obstacles.

10. The method of claim 1, wherein the predetermined point is determined by counting time to travel along a path associated with movement between said opposing obstacles.

11. The method of claim 1, further comprising performing self-diagnostics testing prior to said advancing the robot until it encounters a first obstacle.

12. The method of claim 1, wherein the turn angle is sequentially increased in increments by a multiple of said turn angle after advancing to said predetermined point.

13. The method of claim 1, wherein the turn angle at each predetermined point associated with a path is incrementally increased by a factor of X degrees+nX degrees, where X is the predetermined turn angle and n is a positively increasing integer beginning with 1.

14. The method of claim 13, wherein the robot alternates the turn angle between counter-clockwise and clockwise directions after each sequential arrival at a predetermined point along its associated path.

15. Apparatus for cleaning the surfaces of a pool by a robotic pool cleaner, the apparatus comprising:
means for advancing the pool cleaner until it encounters a first obstacle;
means for reversing the pool cleaner and advancing it away from the first obstacle to an opposing second obstacle to form a first path between the opposing first and second obstacles;
means for reversing the robot at the second obstacle and advancing it to a predetermined point between said opposing obstacles along said first path;
means for turning the pool cleaner in a first direction through a predetermined turn angle;
means for repeating the above steps along additional paths until a sum of said predetermined angular turns generates a quantity of paths sufficient to clean substantially the entire bottom of the pool.

16. Apparatus for cleaning the surfaces of a pool by a pool cleaning robot initially set at an arbitrary position in the pool, the apparatus comprising:
a housing for a filter for removing debris from said pool;
a reversible motorized drive coupled to said housing and adapted for electrical connection to a power source;
a controller coupled to said reversible motorized drive and having a programmed algorithm for navigating by sending appropriate signals to said reversible motorized drive and operating said apparatus, said algorithm comprising the steps of:
advancing the pool cleaner until it encounters a first obstacle;
reversing the pool cleaner and advancing it away from the first obstacle to an opposing second obstacle to form a first path between the opposing first and second obstacles;
reversing the pool cleaner at the second obstacle and advancing it to a predetermined point between said opposing obstacles along said first path;
turning the pool cleaner in a first direction at a predetermined angle of turn;
repeating the above steps along additional paths until a sum of said predetermined angular turns generates a quantity of paths sufficient to clean substantially all of the said pool surface; and
at least one sensor for sensing an obstacle and sending a signal to the controller indicating that an obstacle has been encountered.

17. The apparatus of claim 16 further comprising a counter coupled to said controller, said counter counting time associated with the pool cleaner's movement along a path between opposing obstacles.

18. The apparatus of claim 17, wherein said controller determines the predetermined point between opposing obstacles from the time counted by said counter.

19. The apparatus of claim 18, wherein the predetermined point is a location associated with a time count in a range of approximately 30% to 70% of the total time count taken along a path between said opposing obstacles.

20. The apparatus of claim 18, wherein the predetermined point is a location associated with a count time of approximately 50% of the total count time taken along a path between said opposing obstacles.

21. The apparatus of claim 16, wherein said programmed algorithm is stored in the memory of said controller.

22. The apparatus of claim 16, wherein said programmed algorithm is installed in said controller from an external source via a universal serial bus coupled to said controller.
